(19) United States
(12) Patent Application Publication
(10) Pub. No.: US 2005/0109062 A1
(43) Pub. Date: May 26, 2005

(54) Device and method for the production of high-melting glass materials or glass ceramic materials or glass material or glass ceramic material

(76) Inventors: Thomas Stelle, Mainz (DE); Thomas Kirsch, Mainz (DE); Uwe Kolberg, Mainz (DE); Paul Kissl, Mainz (DE); Ulrich Peuchert, Bodenheim (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/963,759

(22) Filed: Oct. 14, 2004

(30) Foreign Application Priority Data
Oct. 14, 2003 (DE) 103 48 466.3

(51) Int. Cl. C03B 5/44; C03B 5/26; C03C 3/089; C03C 3/091

(52) U.S. Cl. 65/32.1; 65/374.12; 65/157; 65/325; 65/327; 65/356; 65/128; 65/129; 501/65; 501/66

(57) ABSTRACT

The invention relates to a device for the production of high-melting glass materials or high-melting glass ceramic materials, comprising a vessel for accommodating molten glass and a container that accommodates the vessel, whereby the vessel has a tubular outlet. According to the invention, the device is characterised by the fact that the vessel and a first section of the tubular outlet if formed of iridium or a material with a high iridium content, whereby the container is designed to accommodate the vessel and the first section of the tubular outlet under a protective gas atmosphere. The invention also relates to a corresponding method. The molten glass is shaped into a formed part in a discontinuous operation. The choice of the material for the vessel used as the crucible allows the attainment of high temperatures according to the invention which enables glass materials or glass ceramic materials with a much higher spectral transmission in the visible wavelength range. The use of an inert protective gas enables the prevention of unwanted oxide formation on the vessel and the tubular outlet. According to the invention, the glass can be used as a transitional glass between types of glass with very different coefficients of thermal expansion.

### FIELD OF INVENTION

The invention relates to a device and a method for the production of high-melting glass materials or glass ceramic materials. To be more precise, the invention relates to a device and a method for the production of formed parts, for example rods, or other solid parts, and tubes, or other hollow parts, made of high-melting glass materials or glass ceramic materials in a discontinuous operation. In addition, the invention relates to a high-melting glass material or a high-melting glass ceramic material and formed parts produced therefrom.

### RELATED ART

Generally, the invention relates to glass materials or glass ceramic materials comprising a very low content of network modifiers, in particular alkali oxides, and glass materials or glass ceramic materials comprising a high content of high-melting oxides, such as, for example, SiO₂, Al₂O₃, ZrO₂, Nb₂O₅ or Ta₂O₅. Glass materials or glass ceramic materials of the aforementioned type have relatively high melting temperatures in the range of approximately 1700° C. To produce them, molten glass has to be heated, often for long periods, to relatively high temperatures, for example to refine the molten glass. The relatively high temperatures required in continuous operation place new requirements on the design of crucibles.

FIG. 1 shows a device for the production of tubes and rods in discontinuous operation known from prior art. The device has a crucible 2 serving as a melting vessel that is usually made from Pt and Pt alloys, for example PtRh30. The crucible 2 has a cylindrical shape and a base that also comprises a noble metal in which the glass mixture or broken glass is first melted and then refined at an approximately 50-100° C. higher temperature. To heat the crucible 2, a heating device 3 is arranged around the crucible 2. Generally, the heating is inductive, but it may also take the form of direct or indirect resistance heating.

The crucible 2 is usually sealed by a lid (not shown) comprising a fire-resistant material or a noble metal in order to ensure that the surface temperature is sufficient to avoid large temperature gradients. However, optionally the heating may also be provided actively or electrically by means of burners. It is self-evident that the higher the temperature level selected, the quicker and more economical the described processes of melting and fining will be. To achieve high homogeneity of the molten glass, the molten glass may be stirred using a noble metal stirrer, made, for example of the aforementioned Pt alloys or of pure platinum.

As FIG. 1 shows, a tube 4 comprising one of the aforementioned noble metals is welded-on under the crucible 2 with said tube being heated by one or more heating circuits that are independent of the crucible heating 2. This ensures that the temperature setting for the tube 4 decisive for the hot forming process can be achieved independently of the temperature setting of the crucible 2.

The device according to FIG. 1 is usually operated in the sequence of the two operating modes described in the following. In the first mode, the tube 4 is first kept relatively cold for melting and refining the molten glass so that the glass already melted in the crucible 2 does not run straight out of the crucible. Molten glass that enters the tube 4 on the floor of the crucible 2, solidifies or sets in the tube 4 to form a stopper that plugs the tube 4 sufficiently to prevent the molten glass from escaping. After molten glass of the desired quality has formed in the crucible 2, the temperature in the crucible 2 is reduced in a second operating mode and increased in the tube 4 until a favourable viscosity profile for the hot forming is obtained for the whole arrangement. In the second operating mode, the temperature in the crucible 2 and in the tube 4 is generally close to the processing point (VA) of the glass to be produced. To produce formed parts, for example rods or tubes, molten glass with the desired viscosity, as established by the temperature of the molten glass and the elements surrounding it, flows out of the tube 4. To form the emerging molten glass into the formed part to be produced there is often a die at the end of the tube 4 serving as a hot forming device, which may also be heated separately from the tube 4 and the crucible 2 and has a special geometric design capable of influencing the quality of the finished product. To produce hollow parts, for example tubes, usually a needle of a suitable diameter is welded into the die.

This arrangement has proved its worth in numerous instances. However, it does has the drawback that the maximum temperature is restricted to approximately 1760° C. and the service life of the device at temperatures as high as this is greatly restricted. However, glass materials or glass ceramic materials that only comprise a very small content of network modifiers, in particular alkali oxides, or glass materials or glass ceramic materials comprising a high content of high-melting oxides such as, for example, Al₂O₃, SiO₂, ZrO₂, Nb₂O₅ or Ta₂O₅ require higher melting temperatures under some circumstances or have to be more sintered than melted at the maximum possible temperatures for uneconomically long processing periods.

EP 1 160 208 A2 discloses a crucible for the continuous production of glass formed parts. The crucible is produced from a metal that is able to withstand the melting point of the glass, namely molybdenum or tungsten. To prevent oxides in the wall of the crucible from diffusing into the molten glass where they can cause discoloration of the glass and result in occlusions in the glass, the wall of the crucible is lined with a layer of a low-reactivity metal that only melts at a high temperature. The lining comprises rhenium, osmium, iridium or alloys of these metals.

The double wall structure of the crucible is comparatively expensive and necessitates a relatively complex structure that must be capable of permitting the establishment of a hydrogen-containing protective gas atmosphere in the internal and external areas of the crucible in order to suppress the combustion of the molybdenum or tungsten at the high temperatures used. However, this hydrogen-containing gas creates various problems: firstly, it is combustible and requires expensive safety systems, secondly the construction materials may be subject to embrittlement and thirdly, and this is of extreme importance with regard to the molten glass, the hydrogen-containing gas prevents the use of glass components with different oxidation stages and easily reducible components. For example, the normal redox fining agents AS₂O₃, Sb₂O₃ and SnO₂ cannot be used, but the fining must be performed with expensive helium and this is relatively inefficient.

This device requires a system of channels to feed the mixture and it is not possible to use a drawing tube with a die for the forming, such as is unavoidable for establishing the viscosity of the glass for precision shaping. This means that, although this device is suitable for ultra-pure silica glass for which no fining agents (=contaminants). Therefore, this device is generally too complex and too expensive for the economical and simple production of high-precision glass parts in a discontinuous operation.

U.S. Pat. No. 6,482,758 B1 discloses the use of a crucible made of Iridium (Ir) for the production of high-melting, crystallising glass materials. However, here, the crucible is removed from the heating unit after the fining and tipped out. It is self-evident that this procedure is only suitable for relatively small crucibles, for example for laboratory-scale experiments, because, due to their weight, large crucibles are not easy to remove manually or if lifting devices are used would deform under their own weight unless they had unaffordable wall thicknesses. In addition, this device cannot be used for complex or defined forming processes, such as tube drawing, but only for casting in a block-shaped compact mould. A further drawback occurs with glass materials with a tendency to crystallise in that with casting over the edge, uncontrolled temperature profiles and/or evaporation products on the upper edge can trigger the unwanted crystallisation.

Also known from prior art are crucibles made of iridium or an alloy with a high iridium content. Crucibles of this kind are used in crystal growing, for example for crystal growing in accordance with the known Czochralski process. In such cases, starting materials are again melted at high temperatures. However, crystals are a completely different class of substance with completely other processing properties. For example, the known fining process and the addition of a fining agent are omitted during crystal growth. The forming is also quite different because the shape of a grown crystal is determined by the seed crystal and the forming of the generally very complex drawing device. Crystal drawing devices cannot, therefore, be used to produce glass materials. Since crystals solidify suddenly at a defined temperature, hot forming processes involving a tube system and temperature reduction with a subsequent increase in viscosity over several hundred degrees are in principle not possible either.

U.S. Pat. No. 4,938,198 discloses a device and a method for the production of greatly reducing phosphate glass materials with a vessel for accommodating molten glass and with a container that accommodates the vessel whereby the vessel comprises a tubular outlet, the vessel and the tubular outlet comprise oxygen-permeable platinum or an oxygen-permeable platinum alloy and whereby the container is designed to accommodate the vessel and the tubular outlet under an oxygen atmosphere.

This publication also refers to the fact that the vessel for accommodating the melt should not be made of iridium or an iridium alloy since the processing of iridium to produce a vessel is relatively difficult and the external surface of the vessel has to be coated with an inert metal, such as rhodium, which is expensive.

JP 02-022132 A discloses a device for the production of molten glass in the temperature range 1000° C. to 2000° C. It also discloses the fact that iridium is in principle suitable as a high-temperature material in order to prevent the corrosion, caused by the presence of melts at high temperatures, of the vessel for accommodating the molten glass. However, no specific measures regarding the heating, the choice of fireproof material, the hot forming, the type of glass used, the system control or the stabilisation of the iridium or the iridium alloy are disclosed.

### SUMMARY OF INVENTION

It is the object of the invention to provide a method and device with which high-melting glass materials or high-melting glass ceramic materials may-be produced reliably and in a suitable quality. In addition, the invention is intended to provide a high-melting glass material and a high-melting glass ceramic material with even better properties.

According to the invention, a device is provided for the production of high-melting glass materials or high-melting glass ceramic materials, comprising a vessel for accommodating molten glass and a container that holds the vessel whereby the vessel has a tubular outlet. According to the invention, the device is characterised by the fact the vessel and a first section of the tubular outlet is formed of iridium or a material with a high iridium content, whereby the container is designed to accommodate the vessel and the first section of the tubular outlet under a protective gas atmosphere.

High-melting glass materials or high-melting glass ceramic materials within the meaning of this application should be understood to mean in particular glass materials or glass ceramic materials that are produced in a process during which the temperatures exceed the normal maximum temperature of 1760° C. determined by the platinum-containing material of the conventional crucible. This does not exclude the possibility that the melting point of the molten glass could itself be below 1760° C. As will be described in more detail below, according to the invention, however, temperatures of approximately 2000° C. or even up to approximately 2200° C. may be achieved. Since, according to the invention, higher temperatures may be achieved for melting and fining the molten glass, it is possible to achieve high-melting glass materials or glass ceramic materials of this type with surprisingly advantageous properties, in particular with regard to optical transmission, thermal expansion and use as transitional glass materials to connect two types of glass material with different coefficients of thermal expansion.

The inventors discovered that the aforementioned relatively high temperatures may easily be achieved when using iridium or a material with a high iridium content. Iridium itself is known to have a melting point of approximately 2410° C. to approximately 2443° C. and alloys with a high iridium content have an only slightly lower melting point. Even if this means that, according to the invention, processing temperatures of up to approximately 2400° C. are in principle feasible, according to the invention, for safety reasons, a temperature interval of approximately 100° C. to approximately 200° C. from this upper limit should be adhered to, for example to avoid local overheating, inadequate temperature measurements or reduced stability due to the iridium's grain boundary growth. Extensive test series performed by the inventors revealed that even at the aforementioned high temperatures, iridium itself only reacts to a relatively low degree with the molten glass.

According to the invention, iridium oxide formation at high temperature in the presence of oxygen may be prevented in a surprisingly simple way by designing the container so that the iridium or material with a high iridium content in the device, in particular the vessel and the first section of the tubular outlet, is accommodated under a protective gas atmosphere. An advantageous feature is that this achieves a device that is stable for a long time.

The vessel for accommodating the molten glass preferably has a tubular shape with slim basic shapes being quite particularly preferred because this enables homogeneous temperature profiles to be established in the vessel. However, in principle flattened cylindrical profiles are also suitable. The vessel has a tubular outlet through which the molten glass emerges. Preferably, the tubular outlet is located close to the base of the vessel and is preferably arranged in the base, quite particularly preferably in a substantially centrosymmetric arrangement so that the molten glass can substantially completely run out of the vessel. To enable the molten glass to run out more easily and more completely, the base of the vessel may be inclined or cambered towards the outlet. Preferably, the vessel's tubular outlet itself determines the profile of the formed part to be produced. The tubular outlet is connected to the vessel, whereby the first section preferably comprises the same material as the actual vessel.

The container accommodates the vessel and the first section of the tubular outlet. To this end, the container preferably comprises straight side walls and a base. Expediently, the vessel is arranged in the centre of the container and an upper edge of the actual vessel does not actually protrude over the upper edge of the container so that the iridium or material with a high iridium content in the vessel is entirely accommodated in the container.

Preferably, the base of the container contains an opening through which the tubular outlet protrudes into the ambient atmosphere. Advantageously, the molten glass is able to leave the vessel and be processed without the vessel having to be removed from the container because oxide formation on the iridium or material with a high oxide-content can be reliably prevented.

In this embodiment, the tubular outlet has a second section. Here, both the first section and the second section of the tubular outlet may in turn be divided into a plurality of sections. According to the invention, at least one segment of the second section is made of an oxidation-resistant alloy and exposed to an ambient atmosphere. The second section may be relatively short compared to the first section. This enables oxide formation on the first section of the outlet tube to be reliably prevented. The second section may be shorter than the first section. However, attention should be paid to the dependence of the different specific resistances of the materials or the use of a second heating circuit may become necessary.

Expediently, the tubular outlet itself, for example the second segment located outside the container or a segment thereof, functions as a hot forming device in order to shape the molten glass emerging from the tubular outlet into a formed part, for example into a round solid profile. Obviously, hollow formed parts may also be produced with the aforementioned profiles; to this end, a needle with a suitable profile is arranged in the tubular outlet, preferably at its outlet end. Alternatively, a hot forming device may also be arranged at the outlet end of the tubular outlet.

According to another embodiment, the iridium comprises an iridium content of at least approximately 99%, more preferably at least approximately 99.5% and even more preferably at least approximately 99.8%. Quite particularly preferably, the noble metal content of the iridium is at least 99.95%. Other elements of the platinum group could be mixed with the iridium, preferably in concentrations of less than approximately 1000 ppm. In principle, also suitable as a material with a high iridium content is a platinum group metal alloy with an iridium content of at least approximately 95%, more preferably at least approximately 96.5% and even more preferably at least approximately 98%. It was surprisingly found that the aforementioned materials may easily be produced in sheet form and shaped into the vessel or tubular outlet in the desired design. Even thin-walled profiles still have adequate dimensional stability at the aforementioned relatively high temperatures.

According to another embodiment, the vessel and the tubular outlet or at least one segment of the first section of the tubular outlet are formed from a comparatively thin sheet that is suitably shaped, for example bent or folded. The side edges of the sheets are then welded. To this end, suitable welding methods are available which will ensure that the welded edges do not themselves cause any further contamination of the molten glass. In principle, the vessel and the tubular outlet or the at least one segment of the first section of the tubular outlet may also be formed from more than one sheet.

Preferably, the oxidation-resistant alloy used to form the second section of the tubular outlet exposed to the ambient atmosphere comprises a platinum group metal alloy containing approximately 30% by weight to approximately 99% by weight platinum into which is mixed an element from the platinum group, i.e. a group comprising iridium (Ir), osmium (Os), palladium (Pd), rhodium (Rh) and ruthenium (Ru). Expediently, the oxidation-resistant alloy is a PtRh30 alloy that is obtainable at little cost, easy to process and weld and sufficiently dimensionally stable and temperature-resistant. It has been found that at the processing temperatures envisaged according to the invention, i.e. the temperatures at which the molten glass first emerges from the tubular outlet and hence comes into contact with the material in the second section, the relatively low rhodium content only results in a slight discoloration of the molten glass. Quite particularly preferably, the oxidation-resistant alloy is a PtRh20 alloy that is even more inexpensive and results in even less discoloration of the molten glass.

According to another embodiment, the vessel and tubular outlet are heated by means of at least two heating devices that may be controlled or regulated independently of each other. This means that it may be guaranteed that the actual vessel is maintained at the aforementioned relatively high temperatures, for example for the fining of the molten glass, while the tubular outlet or at least its second section, which comprises the oxidation-resistant alloy with a lower melting point than that of the iridium, may be maintained at a temperature below the melting point of the oxidation-resistant alloy. In addition, it is possible to establish a suitable temperature profile in the device during the heat forming of the molten glass, for example even slightly different temperatures in the vessel and in the tubular outlet.

The tubular outlet may be heated by an external heating device, for example by an external induction coil surrounding the outlet. Preferably, the tubular outlet is heated electrically by means of resistance heating. Quite particularly preferably, the heating current is applied directly to the wall of the tubular outlet.

Since the tubular outlet may comprise two different materials according to another embodiment, the lengths of the two sections of the tubular outlet and/or its wall thicknesses are preferably designed so that there is a substantially constant temperature profile along the tubular outlet when the heating current flows through its walls. It is advantageous that, due to the same resistances in the different tubular sections, preferably only one heating circuit is required to guarantee a homogeneous temperature in the tubular outlet. This results in less technical complexity and less expense. If, technical requirements mean it is not possible to adapt the resistances in the tubular segments, it is also possible to use a second heating circuit.

In the case of embodiments in which the first section of the tubular outlet is made of iridium or a material with a high iridium content and in which the oxidation-resistant alloy in the second section is made of PtRh20 or PtRh30, the ratio of a length of the first section to a length of the second section may be, for example, approximately 2.0 and a wall thickness of the first section may be, for example, approximately 70% of the wall thickness of the second section.

If the first and/or second section of the tubular outlet comprise several segments, these preferably have a positive connection with each other in particular by means of a welded joint. However, according to the invention, the materials used for the first and second section will generally have a distinctly different melting points. Hence, it is normally difficult to provide a positive connection, in particular a welded joint, between the first section and the second section. Surprisingly, the inventors found that a tubular outlet designed as an outlet tube may be used to achieve a sort of plug coupling in which one section is pushed onto the other section with the two sections slightly overlapping. In the overlapping area, there may be a non-positive or frictional connection between the two sections. Surprisingly, even if the two sections are not welded together, the aforementioned plug coupling ensures that no molten glass can escape from out of the side of the outlet tube. It was also found that the known Kirkendall effect (pore formation in Ir as a result of the diffusion of iridium into the Pt/Rh20) during the service life of the device has no impacts on mechanical stability. Here, once again, no emergence of glass due to crack formation was observed.

According to another embodiment, the aforementioned plug coupling is realised so that a bead comprising low-melting material in the second section lies around the high-melting material in the first section with said bead being jammed by the stresses that occur on solidification.

According to another embodiment, the vessel to accommodate the molten glass is covered by a cover providing thermal insulation for the molten glass and/or further protection for the molten glass against the ambient atmosphere. The cover may comprise a ceramic material. Preferably, the cover has a lid that may be opened on the melting down of the molten glass raw material for the introduction of more raw material, for example by twisting or displacing. Preferably, the lid comprises an oxidation-resistant alloy, preferably a PtRh20 alloy that may be obtained for little cost and is sufficiently dimensionally stable and low-reactive.

However, it is also possible to use Ir or Ir alloys as lids. In this case, as with the oxidation protection for the outlet tube, here it is possible to use a combination with an oxidation-resistant noble metal or a noble metal alloy and with iridium or an alloy with a high iridium content for the lid, whereby the iridium or the alloy with a high iridium content is arranged inside the container with the protective gas atmosphere and the oxidation-resistant noble metal or the noble metal alloy may also be arranged outside the container with the protective gas atmosphere. Preferably, a Pt/Rh20 alloy is used as a noble metal alloy in this embodiment.

In a further embodiment, the vessel and the cover may be pressure-tight. To this end, the upper edge of the vessel and an internal circumference of the cover may be ground smooth and a sealing means, for example a metal ring, may be provided on the upper edge of the vessel. With this embodiment, the vessel has a gas inlet so that a gas under overpressure may be introduced into the interior of the vessel in order further to encourage the emergence of the molten glass out the tubular outlet. The overpressure in the vessel may, for example, also compensate the decreasing hydrostatic pressure on the emergence of the molten glass from the vessel. For the control or regulation of the overpressure in the vessel, it is possible to provide a control or regulating device that receives a signal from a pressure sensor provided in the vessel or in the cover.

According to another embodiment, an inert gas is used to establish a certain overpressure in the vessel. Particularly preferably, this inert gas has the same composition as the gas used to establish a protective gas atmosphere in the container.

At the relatively high temperatures achievable according to the invention, the thermal radiation losses increasing with the temperature to the fourth power are particularly serious. In order to ensure a homogeneous temperature profile in the vessel, the vessel preferably has an orifice ratio h/L that is much greater than one, whereby h is a maximum internal height of the vessel and L is a maximum distance from the vessel's side walls or the diameter of the cylindrical vessel. Expediently, the orifice ratio is greater than approximately 2.0, more preferably more than approximately 3.0 and even more preferably more than approximately 4.0. However, due to the higher temperature, there is also a higher radiated power. This means the ratios achieved can again be less than those known from prior art. These are required to obtain an increase in the meltable volume with little technical complexity since, although the volume is proportional to the height, it is also proportional to the square of the diameter.

According to another embodiment, at least temporarily, an inert protective gas is supplied to the container for the establishment of an adequate protective gas atmosphere. To this end, the container comprises a gas inlet with which to feed an inert protective gas into the interior of the container connecting the container with a gas reservoir. Preferably, the inert protective gas is designed to maintain neutral to slightly oxidising conditions in the interior of the container.

Particularly suitable as the protective gas are argon or nitrogen, which are simple to handle and cheap to obtain. The inventors have found in extensive test series that mixtures with an oxygen content of between approximately 5×10⁻³% and approximately 5% and more preferably between approximately 0.5% and approximately 2% are advantageous because these can prevent reactions between the material used for the vessel and the glass components, in particular the reduction of glass components with subsequent alloy formation. Compared to conventional crucibles, in which primarily tungsten or molybdenum is used as a substrate for an internal lining in the crucible, according to the invention it is possible to completely dispense with the use of a hydrogen-containing protective gas resulting in a simplification of the structure and a broader range of applications with regard to the glass composition. In addition, according to the invention, the normal redox fining agents, such as for example As₂O₃, Sb₂O₃, SnO₂ may be used. In principle, it is also possible to dispense with the use of expensive He to reduce bubble formation during the fining of the molten glass.

To establish the protective gas atmosphere, the protective gas may be passed continuously through the container. Preferably, the container has a cover that serves not only to provide thermal insulation for the vessel arranged in the container but also to retain a certain amount of the protective gas in the interior of the container. In this way, an equilibrium of flow of the protective gas atmosphere can be guaranteed with a low protective gas flow rate.

According to a further embodiment, the container may be designed to be pressure-tight so that it is possibly completely to suppress any exchange of the protective gas in the interior of the container. In order to establish an overpressure, a pressure-relief valve may be provided in the container. In addition, a gas outlet may be provided to discharge the inert protective gas from the interior of the container.

According to another embodiment, the vessel is heated by an induction coil wound around the vessel. The basic shape of the induction coil is preferably adapted to match the basic shape of the vessel, whereby the vessel is preferably arranged centrosymmetrically within the induction coil. The induction coil is arranged at a suitable, short distance from the vessel and preferably extends over the entire height of the vessel. Preferably, the induction coil is wound in a spiral with a pitch different from 0° because this permits the achievement of more homogeneous temperature profiles. However, the induction coil may also be wound around the vessel in a wave-shape, divided when viewed from the side into rectangular segments, with a pitch of the individual segments of the induction coil of substantially 0°. Preferably, the induction coil is water-cooled.

According to a further embodiment, a heat-resistant jacket is provided between the side wall of the vessel and the induction coil, preferably with the same basic shape as the vessel. If the vessel has a circular cross section, the jacket is designed as a cylinder. The material used for the cylinder or the jacket should be able to withstand the prevailing ambient temperature around the vessel. Preferred, therefore, are materials that are also still adequately dimensionally stable at temperature of approximately 1750° C., for example a ceramic fibre protective sheath made of ZrO₂ or Al₂O₃ fibres. The use of fibre materials is advantageous because they have a lower thermal conductivity than solid ceramic materials. However, it is also possible to use ceramic materials with an adequate stability and insulating effect at 1750° C., for example sillimanite.

Preferably, a filling of heat-resistant pellets is provided between the side wall of the vessel and the jacket or the cylinder. The pellets do not necessarily have to be spherical, but could also have, for example, an elliptical shape or an irregular shape. The filling lying on the outer wall of the vessel and on the internal wall of the cylinder or the jacket effects a homogenisation of the pressures and the absorption of the mechanical stresses around the vessel. Therefore, the filling counteracts any deformation of the vessel, due, for example, to the softening of the side walls of the vessel. Overall, therefore, even at the very high temperatures of up to approximately 2000° C., preferably 2200° C., according to the invention, it is possible to achieve adequate dimensional stability of the vessel used for the melting and fining of the glass. They also ensure an adequate insulating effect to enable the aforementioned materials to be used as a heat-resistant jacket.

Preferably, the inert gas used to establish the protective gas atmosphere also passes through the filling of pellets in order to prevent oxide formation on the vessel. Extensive test series performed by the inventors found that an adequate gas through-flow may be achieved if the pellets in the pellet filling have a diameter of at least approximately 2.0 mm, more preferably at least approximately 2.5 mm and even more preferably at least approximately 3.0 mm. In principle, however, an adequate gas through-flow may also be achieved by an irregular surface shape of the pellets right up to a basic shape tending towards the cuboidal. Preferably, the pellets in the pellet filling comprise magnesium oxide (MgO) because this material is sufficiently heat and oxidation-resistant and dimensionally stable. The use of ZrO₂ is also possible.

According to a further aspect of the invention, a method for the production of high-melting glass materials or glass ceramic materials is provided comprising the following steps: providing of a vessel for accommodating molten glass whereby the vessel has a tubular outlet, disposing of the vessel in a container, introducing of a raw material or a mixture with a prespecified composition into the vessel and the melting of the raw material to produce molten glass and the fining of the molten glass, whereby the vessel and a first section of the tubular outlet is made of iridium or a material with a high iridium content and a protective gas atmosphere is provided in the container in such a way that the vessel and the first section of the tubular outlet are accommodated in the container under the protective gas atmosphere.

With the method according to the invention, the above-mentioned device is operated in two different operating modes in sequence. In a first operating mode, the mixture is introduced into the vessel for melting down. The temperature of the vessel is then increased to the above-mentioned relatively high temperatures at which the molten glass is refined in the known way. These temperatures are way above the subsequent processing temperature chosen for the molten glass. In the first operating mode, the tubular outlet is preferably maintained at a much lower temperature at which the molten glass solidifies or hardens in order to form a stopper that blocks the tubular outlet and prevents the molten glass from running out. In order to achieve an even more homogeneous end product, therefore, the first part of the molten glass emerging during the later hot forming may be separated off. During the fining, the heating of the tubular outlet may be switched off or suitably controlled or regulated to compensate heat losses.

In a subsequent, second operating mode, following the fining, the temperature of the molten glass is reduced to the actual processing temperature and the tubular outlet is heated to the processing temperature. In the second operating mode, the vessel and the tubular outlet may be kept at the same temperature or at different temperatures.

According to the invention, during the first operating mode, temperatures of at least approximately 2000° C., more preferably of at least approximately 2100° C. and even more preferably of at least approximately 2200° C. may be achieved. In principle, any glass compositions may be treated at these temperatures.

Particularly preferably, according to the invention glass compositions are used that comprise approximately 80% to approximately 90% SiO₂, approximately 0% to approximately 10% Al₂O₃, approximately 0% to approximately 15% B₂O₃ and less than approximately 3% R₂₀ whereby the content of Al₂O₃ and B₂O₃ together is approximately 7% to approximately 20% and R stands for an alkali element from a group comprising Li, Na, K, Rb and Cs. As will be described in more detail in the following, transitional glass materials with even more advantageous properties may be achieved in this way, in particular with regard to their optical transmission, their thermal expansion and their homogeneity. In addition, cordierite glasses with even more advantageous properties may be produced.

Expediently, the glass composition may additionally contain further high-melting oxides, for example, up to approximately 20% MgO and/or up to approximately 10%, more preferably up to approximately 5% of TiO₂, ZrO₂, Nb₂O₅, Ta₂O₅, WO₃ or MO₃ or mixtures thereof.

It has been found to be particularly advantageous if the molten glass in the vessel is stirred during the first operating mode or during the fining by means of a stirring device made of iridium or a material with a high iridium content with the above-described properties. The stirring device may be connected to a gas reservoir in order to blow in a gas to reduce the molten glass. In addition, this may also additionally homogenise the melt. Other effects include the acceleration of the melting and fining. Blowing in a gas can also achieve the drying of the glass or a reduction of the OH (water absorption band) in the NIR (near infrared region). This may also reduce the residual gas content in the glass, which may be advantageous for subsequent hot reprocessing.

According to a further aspect of the invention, that may also be claimed independently, a high-melting glass material or a high-melting glass ceramic material is provided comprising approximately 80% to approximately 90% SiO₂, approximately 0% to approximately 10% Al₂O₃, approximately 0% to approximately 15% B₂O₃ and less than approximately 3% R₂₀ whereby the content of Al₂O₃ and B₂O₃ together is approximately 7% to approximately 20%. According to the invention, the glass material or glass ceramic material is characterised by the fact that transmission in the visible wavelength range between approximately 400 nm and approximately 800 nm based on a substrate thickness of approximately 20 mm, is at least approximately 65%, more preferably at least approximately 75% and even more preferably at least approximately 80%. Preferably, the glass material or glass ceramic material is provided by means of the device according to the invention or the method according to the invention. Glass materials or glass ceramic materials with the above composition and with the aforementioned advantageously high transmission in the visible wavelength range are not currently known from prior art. These glass materials may be used, for example, as viewing glasses in furnaces or similar systems.

Preferably, the transmission in the range of a water absorption band at approximately 1350 nm is at least approximately 75% and/or the transmission in the range of a water absorption band at approximately 2200 nm is at least approximately 50%, more preferably at least approximately 55%. Such advantageously high optical transmission in the near infrared spectral range is not known from the prior art for glass materials of the aforementioned composition.

A further aspect of the invention relates to the use of the glass material according to the invention as a transitional glass material to connect two types of glass with different coefficients of thermal expansion, for example to establish a fused joint between silica glass and Duran glass that is difficult to achieve due to the large differences in the thermal expansion (α—value: silica glass 0.5×10⁻⁶⁻ K⁻¹, Duran glass 3.3×10⁻⁶ K⁻¹⁾. Preferably, the expansion properties of the glass materials according to the invention are specially matched to each other and according to the invention they are fused together in stages of α=1.3×10⁻⁶⁻ K⁻¹ through α=2.0×10⁻⁶⁻ K⁻¹ to α=2.7×10⁻⁶⁻ K⁻¹ with a tolerance of approximately 0.1×10⁻⁶ K⁻¹.

### BRIEF DESCRIPTION OF DRAWINGS

The invention will now be further described with reference to preferred exemplary of embodiments shown in the drawings from which may be derived further features, advantages and problems to be resolved that are expressly the subject matter of this invention. Here:

FIG. 1 is a schematic cross section of a device according to the prior art

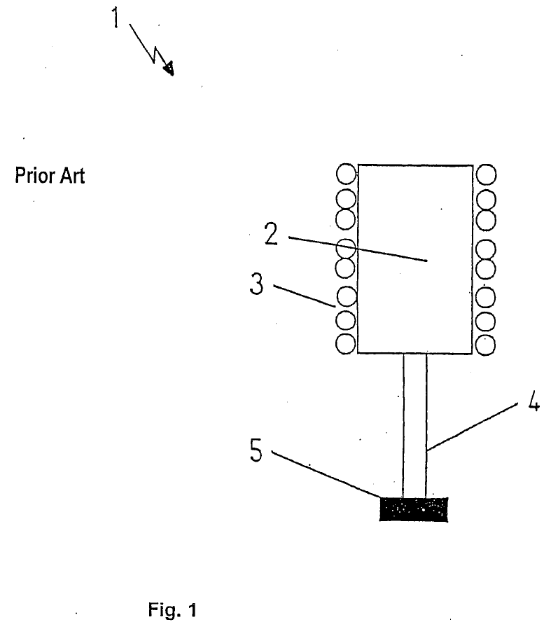

FIG. 2 is a schematic partial section of a crucible with an tubular outlet according to the invention

FIG. 3 is a schematic cross section of a device according to the invention, and

FIG. 4 shows the spectral transmission of an example of a glass according to the invention.

### DETAILED DESCRIPTION OF PREFERRED EMBODIMENTS

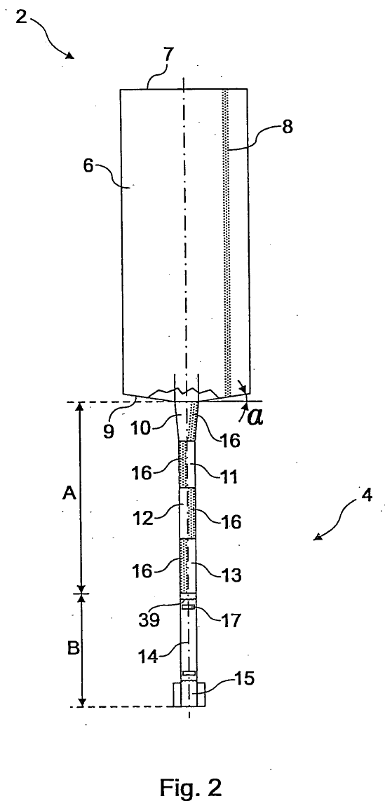

FIG. 2 is a schematic partial section of a crucible 2 serving as a vessel for accommodating molten glass with a tubular outlet 4 according to the invention. In its upper part, the crucible 2 has a crucible wall 6 produced from a sheet that has been suitably cut to size and positively connected along the weld seam 8 by welding. Suitable notches in the sheet ensure that the base 9 is suitably shaped and connected to the rest of crucible wall 6 by means of a weld seam that is not shown.

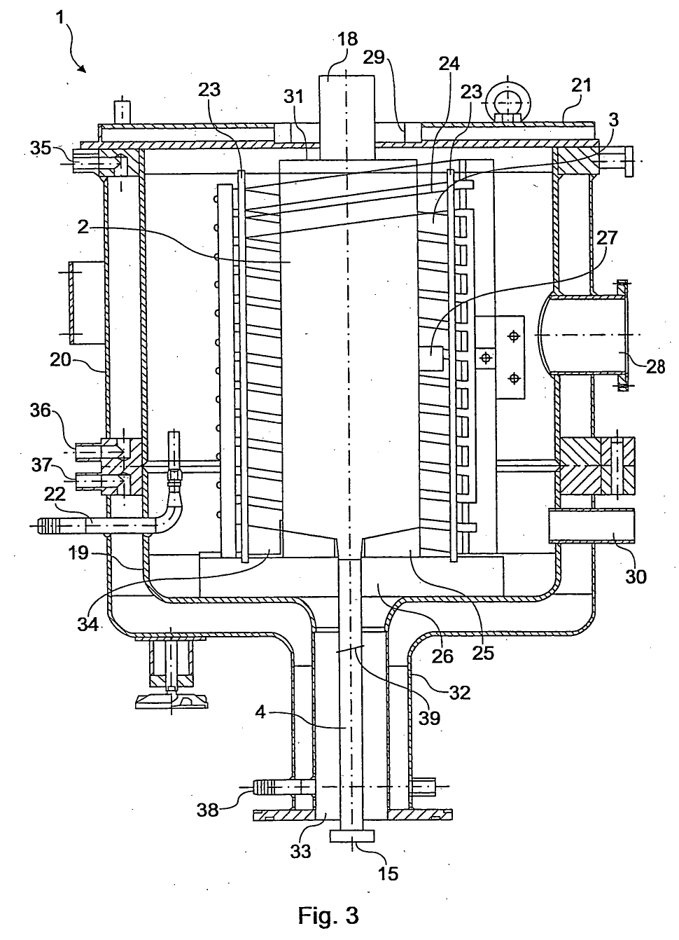

Overall, the upper part of the crucible 6 has a slim shape so that a heating device surrounding the crucible 2, such as that shown, for example in FIG. 3, results in the homogeneous heating of the molten glass accommodated in the crucible 2. An orifice ratio h/L of the cylindrical parts of the crucible 2 is preferably at least larger than approximately 2.0, more preferably larger than approximately 3.0 and even more preferably larger than approximately 4.0, whereby h is a maximum internal height of the cylindrical part of the crucible 2 and L is a maximum distance from the side walls or the diameter of the cylindrical part of the crucible 2.

As shown in FIG. 2, the base 9 is inclined radially inwardly about an angle alpha in the range of up to 20°, preferably in the range of approximately 10°, in order to encourage the running out of the molten glass. In principle, the base 9 may also have a cambered or flat shape.

The outlet tube 4 serving as a tubular outlet, which comprises several segments 10 to 14, starts in the middle of the base 9. In the example shown, the outlet tube 4 has a round cross section. The outlet tube 4 can also have a different cross section. The individual segments 10 to 14 are each produced from one sheet that is suitably cut to size and connected along the relevant weld seam 16 to a tubular body. The upper segment 10 has a conical segment and is connected to the base 9 of the crucible 2. The conical shape encourages the running out of the molten glass from the cylindrical part of the crucible 2 into the outlet tube 4. The other segments 11 to 14 are substantially straight. In the upper part A of the outlet tube 4, the segments 10 to 13 are made of iridium or a material with a high iridium content, as explained in the following. In the lower part B of the outlet tube 4, the segment 14 or the several segments (not shown) comprise an oxidation-resistant alloy, preferably PtRh30 or PtRh20.

At the lower end of the outlet tube 4, there is a draw die 15 that serves as a hot forming device in order to shape the molten glass emerging from the outlet tube 4 to produce a formed part. According to the invention, it is possible to produce solid parts, for example rods, blocks or pellets from a high-melting glass material or a high-melting glass ceramic material or hollow parts, for example tubes, from a high-melting glass material or a high-melting glass ceramic material.

The outlet tube 4 is resistance-heated by means of an electrical current that flows through the wall of the segments 10 to 14. To this end, there are electrical connections for conducting the heating current on the outlet tube 4. One electric connection is located at the end of the tube with the reference number 15, the second electrical connection is located in a duplicate design at the transition between the elements with the reference numbers 9 and 6 and offset by 180° relative to each other in FIG. 2. Reference number 17 designates terminal lugs for the attachment of thermocouples (not shown).

The conical segment 10 is connected to the base 9 of the crucible 2 by means of a weld seam. The other segments 11 to 13 made of iridium or the material with a high iridium content are also preferably connected to each other by means of welded joints. The melting temperatures of iridium or an alloy with a high iridium content and other oxidation-resistant alloys, which are used to form the segment 14 of the section B of the outlet tube 4 differ greatly. Therefore, the segment 14 made of the low-melting oxidation-resistant alloy cannot be connected to the segment 13 made of iridium or the alloy with a high iridium content by means of a welded joint. The joint according to the invention is formed by a sort of plug coupling in which the segment 13 is pushed into the segment 14 with a tight fit. The external diameter of the segment 13 and the internal diameter of the segment 14 are matched to each other so that when the plug connection is formed, a sort of bead comprising the material of the low-melting oxidation-resistant alloy of segment 14 is located around the material of segment 13 which serves to seal the outlet tube 4 in the transitional area 39 between section A and section B. During the course of several temperature cycles, the bead becomes jammed as the result of stresses formed on the repeated solidification of the segments 13, 14. Surprisingly, it has been found that even without a positive connection between the two segments 13, 14, it is possible effectively to prevent the uncontrolled emergence of the molten glass through cracks or holes in the transitional area 39. It was also identified that the known Kirkendall effect (pore formation in Ir due to diffusion of said Ir into the Pt/Rh20) had no impacts on mechanical stability during the service life of the device. Once again, no escape of glass material due to crack formation was observed.

According to a preferred exemplary embodiment, the crucible wall 6 of the crucible 2 is produced from a sheet with a length of approximately 510 mm and wall thickness of approximately 1.0 mm. The cylindrical part of the crucible 2, therefore, has a theoretical capacity of approximately 17 litres. To produce crucibles with larger capacities, the height of the cylindrical part may be increased or both the height and the diameter of the cylindrical part 6 increased with scaling of the specified orifice ratio h/L. Here, it should be noted that the heating device surrounding the cylindrical part 6 of the crucible 2 (see FIG. 3) is designed so that a homogeneous temperature profile can be achieved over the diameter and height of the cylindrical part 6 of the crucible 2.

According to a preferred exemplary embodiment, the segments 10 to 14 and the draw die 15 of the outlet tube 4 may be formed from sheets with a wall thickness of approximately 1.0 mm, as follows: the first conical segment 10 has a length of 68 mm and an internal diameter of 40 mm that tapers to approximately 20 mm at the lower end, the next segment 11 has a length of 90 mm and an internal diameter of 20 mm, the two next segments 12, 13 have a length of 80 mm and an internal diameter of 20 mm, the segment 14 of section B has a length of 145 mm and an internal diameter of 20 mm and the draw die 15 has a length of 35 mm and an internal diameter of 52 mm.

Overall, therefore, the ratio of the length of section A to the length of section B of the outlet tube 4 is approximately 7:3. Preferably, the segments 10 to 13 of section A of the outlet tube 4 comprises iridium or an alloy with a high iridium content, as described in the following, while the segments 14, 15 of section B of the outlet tube 4 comprises PtRh alloy which is temperature-resistant and oxidation-resistant. Particularly, expedient is the use of PtRh30, or even more preferably PtRh20, as the material for segments 14, 15 of section B, because this material may be obtained for less cost, is more suitable for thermoforming and at the temperatures used for hot forming according to the invention only contributes to a slight discoloration of the molten glass.

It is known that the electrical conductivity of iridium or an alloy with a high iridium content is different from that of a PtRh alloy. To ensure that the heating current flowing through the walls of the segments 10 to 15 is substantially constant over the length of the outlet tube 4 in order to achieve a homogeneous temperature profile, in the preferred exemplary of an embodiment the wall thickness of the segments 10 to 13 of iridium or the alloy with a high iridium content is approximately 0.7 mm, while the wall thickness of the segments 14, 15 made of PtRh20 is approximately 1.0 mm if the ratio of the lengths of the sections A and B is approximately 7:3. With other length ratios, a person skilled in the art in this field would be have no difficulty calculating different wall thicknesses for segments 10 to 13 of section A and segments 14, 15 of section B using the electrical conductivities of the materials in question.

As FIG. 2 shows, the upper edge 7 of the crucible 2 is flat. As shown in FIG. 3, a cover 31 is placed on the upper edge 7 that serves to provide thermal insulation for the molten glass accommodated in the crucible 2 and to provide further protection of the molten glass against the ambient atmosphere. The cover 31 may be placed on the upper edge 7. The cover 31 can also be placed on the upper edge 7 and be connected to this so that the crucible 2 has a pressure-tight seal to a certain degree thus enabling the establishment of an atmosphere with a certain overpressure in the crucible 2 by the introduction of a flow of gas, preferably a protective gas, through a gas inlet, not shown, into the interior of the crucible 2 above the level of the molten glass. This overpressure may be used, for example, to compensate the decreasing hydrostatic pressure of the molten glass when the molten glass leaves the outlet tube 4.

According to the invention, the crucible wall 6 and the segments 10 to 13 of the crucible 2 comprise iridium with an iridium content of at least approximately 99%, more preferably at least 99.5% and even more preferably at least approximately 99.8% so that their melting point is approximately 2400° C. Quite particularly preferred is an iridium with an iridium content of at least approximately 99.8% and a content of elements from the platinum group of at least 99.95%. Here, the maximum content of Pt, Rh and W is approximately 1000 ppm each, the maximum content of Fe approximately 500 ppm, the maximum content of Ru approximately 300 ppm, the content of Ni approximately 200 ppm, the maximum content of Mo, Pd approximately 100 ppm each, the maximum content of Cu, Mg, Os, Ti approximately 30 ppm each and the maximum content of Ag, Al, As, Au, B, Bi, Cd, Cr, Mn, Pb, Si, Sb, V, Zn, Zr approximately 10 ppm each.

Other possible materials for the crucible wall 6 and the segments 10 to 13 of the crucible 2 may in principle be materials with a high iridium content formed from a platinum-group alloy with an iridium content of at least approximately 95%, more preferably at least approximately 96.5% and even more preferably at least approximately 98%. When processing the aforementioned materials, it should be noted that they are relatively brittle and only become ductile at comparatively high temperatures.

FIG. 3 shows a schematic cross section of a device for the production of high-melting glass materials or high-melting glass ceramic materials in a discontinuous operation in accordance with the invention. The device 1 comprises the crucible 2 according to FIG. 2, which is accommodated in a container comprising a lower container section 19 and an upper container section 20. The crucible 2 is accommodated in the container in such a way that the upper edge of the crucible 2 does not protrude above the upper edge of the upper container section 20. The upper container section 20 is covered by a cover 21. Overall, the container with this design is adequately sealed from the ambient atmosphere so that a protective gas atmosphere may be established in the interior of the container where the crucible 2 is accommodated in order to prevent unwanted oxidation formation on the iridium or the material with a high iridium content of the crucible 2 and section A of the outlet tube 4 (see FIG. 2).

Arranged around the crucible 2, is a water-cooled induction coil 3 that extends in a spiral and with a non-vanishing pitch around the crucible 2. The induction coil 3 is arranged at a slight distance to the external wall of the crucible 2, preferably a distance of approximately 60 to 80 mm. Between the induction coil 3 and the crucible 2, there is a fireproof cylinder 23 radially surrounding the crucible 2 which is sealed at the bottom by the second base element 26 and the first base element 25. The space formed in this way between the surface of the internal circumference of the fireproof cylinder 23 and the surface of the external circumference of the crucible 2 is filled with MgO pellets 24 in order to ensure that the crucible 2 is sufficiently dimensionally stable even at temperatures of approximately 2000° C. The pellets in the pellet filling 24 must be sufficiently thermally and dimensionally stable and oxidation-resistant at the specified temperatures. Therefore, MgO should preferably be used as the material for the pellet filling, but the invention is not restricted to this. The use of ZrO₂ is also feasible, for example. The pellets in the pellet filling 24 may also have a superficial shape deviating from the circular. Overall, however, a sufficient gas flow, in particular protective gas flow, will be maintained in the space between the surface of the internal circumference of the cylinder 23 and the surface of the external circumference of the crucible 2, so that an inert protective gas flows around the crucible 2 in order to prevent unwanted oxide formation on the iridium or the material with a high iridium content in the crucible 2.

The inventors found that sufficient gas flow may be ensured in the aforementioned space if the pellets in the pellet filling 24 have a diameter of at least approximately 2.0 mm, more preferably at least approximately 2.5 mm and even more preferably at least approximately 3.0 mm.

In a preferred exemplary embodiment, the induction coil 3 is driven by a converter with a connected load of approximately 50 kW at a frequency of approximately 10 kHz. This enables temperatures of above 2000° C. to be achieved in the cylindrical section of the crucible 2 even in long-term operation.

For measuring the temperature in the crucible 2, an iridium sleeve 27 is provided on the surface of the external circumference of the cylindrical section of the crucible 2 in which is arranged a suitable temperature sensor. Also possible is temperature measurement with Ir-PtIr40 thermocouples or with a two-colour pyrometer that may be introduced via a fibre-optic conductor (not shown) comprising, for example, a sapphire fibre (in order to ensure he measurement of temperatures above 2000° C.) through the leadthrough 28 in the upper container section 20. However, also possible is temperature measurement by means of a two-colour pyrometer with no fibre-optic conductor, depending upon the focal distance (measuring distance) and the size of the measuring area. For temperature monitoring, further thermocouples, not shown, for example of type B, are located in the first base section 25 and/or in the second base section 26 and at other suitable places in the container.

As explained above, the container substantially has a three-part design and comprises the lower container section 19, the upper container section 20 and the cover 21. These container sections are expediently produced from a suitable stainless steel. The upper container section 20 has a double-walled design. A coolant, preferably water, may be passed through the annular slit between the internal wall and the external wall in the upper container section 20. To this end, the upper container section 20 has an upper coolant connection 35 and a lower coolant connection 36. The side walls of the upper container section 20 have a cylindrical design as an adaptation to the basic shape of the crucible 2 and the induction coil 3 surrounding this. The distance between the internal wall of the upper container section 20 and the surface of the external circumference of the induction coil 3 is selected as sufficient efficiently to prevent the melting of the internal wall of the container section 20 when the normal heating power is applied to the induction coil 3. In one preferred exemplary embodiment, the distance between the internal wall of the upper container section 20 and the surface of the external circumference of the induction coil 3 is approximately 120 mm.

The upper container section 20 is flanged onto the lower container section 19. Overall, the lower container section 19 is bell-shaped and comprises two cylindrical sections each with a different external diameter. The upper cylindrical section of the lower container section 19 is used to accommodate the crucible 2 and its supporting base elements 25, 26, while the lower cylindrical section of the lower container section 19 is used for the accommodation and leadthrough of the outlet tube 4 to the ambient atmosphere. A coolant, preferably water, may also flow through the annular slit in the lower container section 19 to which end an upper coolant connection 37 and a lower coolant connection 38 is provided on the lower container section 19.

The stainless steel cover 21 is placed, preferably flanged, on the upper circumferential edge of the upper container section 20. The cover 21 may be removed by releasing threaded bolts, not shown, or may be swivel-mounted or laterally displaceable in order to facilitate the replacement of the crucible 2. Above the crucible 2, there is a coping 29 comprised of a heat-resistant material, for example MgO or mullite, preferably with a noble metal lining (Pt/Rh30). The coping 29 may also be lifted or swivelled out of the orifice in the cover 21, for example for maintenance and installation work on the crucible 2 accommodated in the container. As shown in FIG. 3, the crucible 2 is sealed at its upper edge by a cover 31 that in turn has a jacket 18 with a cylindrical shape and penetrates the coping 29 through to the ambient atmosphere. The design of this lid may be implemented either completely in Ir or Ir alloys or in Pt alloys, preferably Pt/Rh 20. Also possible is a combination of the two alloys (part 31—iridium and part 18—oxidation-resistant noble metal, for example Pt/Rh20). The coping 40, preferably made of ceramic material (MgO, mullite) or a ceramic material set in noble metal may be removed to introduce a glass mixture or raw material into the crucible 2 during the melting down of the molten glass and then replaced.

To lead cables and leads into the interior of the container, a leadthrough 30 is provided in the lower container section 19. In particular, a separate gas line (not shown) may be led through the leadthrough for media 30 to the crucible 2 in order to rinse or pressurise the interior of the crucible 2 separately from the interior of the container with a protective gas atmosphere. In the latter case, the crucible 2 may be designed as pressure-tight to a certain extent thus enabling the establishment of a certain overpressure in the crucible 2. A pressure sensor may be provided in the crucible 2 to control or regulate this overpressure, with the cables of said pressure sensor also being led outside through the leadthrough for media 30.

As FIG. 3 shows, the entire area of the base of the crucible 2 is placed on a first base element 25. To this end, the profile of the first base element 25 is adapted to match the shape of the base of the crucible 2, in the exemplary embodiment shown, this is tapered. The first base element 25 provides mechanical support for the crucible 2 and sufficient thermal insulation. In a preferred exemplary embodiment, the first base element 25 comprises MgO.

The first base element 25 supporting the crucible 2, the fireproof cylinder 23 and the induction coil 3 rest on a second base element 26 which is supported on the base of the lower container section 19. The second base element 26 provides a mechanical support for this arrangement and sufficient thermal insulation. The thickness of the second base element 26 is selected appropriately for this end. The material used for the second base element 26 must be sufficiently thermally and dimensionally stable and oxidation-resistant. In a preferred exemplary embodiment, the second base element 26 comprises ZrSiO₄.

The first base element 25 and the second base element 26 have an orifice through which the outlet tube 4 reaches the ambient atmosphere. The lower cylindrical section of the lower container section 19 surrounds the outlet tube 4. Apart from a small section (the segment given the reference number 15) of the lower tube section, the outlet tube 4 comprising oxidation-resistant noble metal is located in the lower container section and is provided with a gas-tight seal by a sealing means, not shown, with the container section 19 to prevent the penetration of atmospheric air.

According to the invention, it is preferable if the transitional area 39 between the section A and the section B of the outlet tube 4 (see FIG. 2) is arranged as far as possible below the two base elements 25, 26. However, a suitable layout of the lower container section 19, may also ensure that the segments of the section A of the outlet tube 4 comprising iridium or the material with a high iridium content are cooled down to such an extent that the risk of oxide formation on the iridium or the alloy with a high iridium content is avoided. The location of the transitional area 39 in FIG. 3 should therefore be only treated as an explanation and not interpreted as being true to scale.

As FIG. 3 shows, there is a gas inlet 22 in the lower container section 19 that serves to supply a protective gas into the interior of the container. The gas inlet 22 is connected to a gas line, not shown, and a gas reservoir, not shown. Overall, therefore, the container is rinsed by a protective gas and the protective gas flows round the crucible 2 accommodated in the container in order effectively to prevent oxide formation on the iridium or the material with a high iridium content in the crucible 2 and section A of the outlet tube 4 (see FIG. 2).

The protective gas maintains neutral to slightly oxidising conditions in the interior of the container. To this end, a protective gas with an oxygen content of between approximately 5×10⁻³% and approximately 5% and more preferably between approximately 0.5% and approximately 2% may be used. Overall, the protective gas used is low-reactive and only reacts with the iridium or the alloy with a high iridium content to a negligible extent. Particularly suitable as inert, low-reactive protective gases are argon or nitrogen. The aforementioned small additions of oxygen are able to suppress reactions between the material of the crucible and glass components (reduction of glass components with subsequent alloy formation). In addition, the interior of the crucible is rinsed with protective gas to protect the internal wall of the crucible against oxidation caused by atmospheric oxygen.

The rinsing with the protective gas may be restricted to the iridium-containing sections of the crucible 2 since it was surprisingly found that an invasion of oxygen with the subsequent destructive oxidation of the crucible 2 only occurs in the top few centimetres of the arrangement, which in the arrangement shown in FIG. 3 preferably comprises a PtRh20 lid 31. However, it is also possible to use a lid comprising iridium or an iridium alloy if small noble metal losses due to the oxidation of the iridium are accepted. To this end, there may be a small gap between the cover 31 and the area of the crucible 2 surrounded by the induction coil 3.

The container does not have to be pressure-tight since it is sufficient for an equilibrium of flow to form in the interior of the container that guarantees a sufficient protective gas atmosphere therein. In principle, however, the container 5 may have a pressure-tight design in order more efficiently to prevent the penetration of oxygen from the ambient atmosphere into the interior of the container.

According to the invention, the use of iridium or an alloy with a high iridium content for the crucible permits melting temperatures of approximately 2000° C. or above. This considerably accelerates all the physical and chemical aspects of the melting process. The processing times are significantly reduced in conjunction with a simultaneous increase in quality. Consequently, the invention may be used to produce glass materials or glass ceramic materials with new surprisingly advantageous properties.

Quite generally, the device according to the invention is operated in two different operating modes. Firstly, by opening the lid 18 enables a quantity of glass material or a corresponding raw material to be successively is introduced into the crucible 2. During this low-melting phase, the temperature of the crucible 2 may also be selected correspondingly low, preferably, however, the temperature of the crucible 2 is kept above approximately 2000° C. even during the low-melting phase.

For the further treatment of the molten glass, in particular for the fining, the temperature of the crucible 2 is maintained by means of the induction coil 3 way above the later processing temperature of the molten glass. The very high temperatures possible according to the invention mean the fining processes can take place much more effectively. In this first operating mode, the temperature of the outlet tube 4 is kept comparatively low and below the melting temperature of molten glass. As a result, a stopper comprising viscous or solidified molten glass forms in the outlet tube 4 and this prevents the molten glass from running out of the crucible 2. During the fining process, conventional fining agents in the molten glass are activated. A stirring device, not shown, may be arranged in the crucible 2 or inserted therein through the cover 31 to stir the molten glass in the crucible 2. According to the invention, the stirring device comprises the aforementioned iridium or the aforementioned alloy with a high iridium content. According to the invention, the actual stirring device may also be used to blow in gases, for example reducing gases.

The transitional area between the liquid molten glass and the highly viscous or solidified stopper is fluid, but is preferably located outside the outlet tube 4. This means a very homogeneous molten glass is established inside the crucible 2.

During the first operating mode, the outlet tube 4 does not necessarily have to be heated because a suitable layout of the lower cylindrical section of the lower container section 19 can ensure suitable cooling of the outlet tube 4 by means of heat dissipation. In principle, however, the outlet tube 4 may also be subject to controlled or regulated heating or cooling during the first operating mode.

Following fining, when molten glass of a suitable quality has established itself in the crucible 2, the temperature of the molten glass in the crucible 2 may be reduced to the processing temperature to adopt a second operating mode and the outlet tube 4 is heated to the processing temperature. The processing temperature is selected so the molten glass has a desired viscosity or is suitable for the production of formed parts. The processing temperature is higher than the melting point of the molten glass and can be altered by changing the heat output from the induction coil 3 and the heating current heat output on the outlet tube 4. The crucible 2 and the outlet tube 4 can also be held at different temperatures, for example with a temperature difference of approximately 10 to 40° C.

In the second operating mode, the stopper in the outlet tube 4 melts or softens so the molten glass runs out of the outlet tube 4. Here, the molten glass is formed through the profile of the outlet tube 4 and/or through further heat forming devices, for example a draw die, as indicated in FIG. 3 with reference number 15. According to the invention, both solid parts, for example rods, and hollow parts, for example tubes, may be produced.

Instead of glass formed parts, the emergent molten glass may also be quenched and hence further processed to produce a powder.

The device according to the invention may, in principle, be used to produce all known types of glass material. However, the device according to the invention is particularly preferred for glass materials or glass ceramic materials comprising only a very low content of network modifiers, in particular alkali oxides, or for glass materials or glass ceramic materials comprising a high content of high-melting oxides, such as, for example, SiO₂, Al₂O₃, Nb₂O₅ or Ta₂O₅. According to the invention, the glass material or the glass ceramic material have an SiO₂ content of approximately 80% to approximately 90%, an Al₂O₃ content of approximately 0% to approximately 10%, a B₂O₃ content of approximately 0% to approximately 15% and an R₂₀ content of less than approximately 3%, whereby the content of Al₂O₃ and B₂O₃ together is approximately 7% to approximately 20% and R stands for an alkali element of a group comprising Li, Na, K, Rb and Cs. Glass materials with the aforementioned composition cannot be produced using crucibles known from prior art, or at least not with sufficient quality.

Expediently, the glass composition can also comprise still further high-melting oxides for example, up to approximately 20% MgO and/or up to approximately 10%, preferably up to approximately 5% of TiO₂, ZrO₂, Nb₂O₅, Ta₂O₅, WO₃ or MoO₃ or mixtures thereof.

A preferred usage according to the invention relates to the production of so-called transitional glass materials that serve to produce a fused joint between a glass material with a low coefficient of thermal expansion and a glass material with a high coefficient of thermal expansion, for example between silica glass with a coefficient of thermal expansion of 0.5×10⁻⁶ K⁻¹ and Duran glass with a coefficient of thermal expansion of approximately 3.3×10⁻⁶ K⁻¹. According to the invention, transitional glass materials may be produced with coefficients of thermal expansion that have been specially adapted to the two types of glass to be joined, as described below.

Table 1 summarises the composition and the coefficients of thermal expansion determined for different transitional glass materials produced in accordance with the invention and the following example of an embodiment.

TABLE 1

| Oxides | | | | | |
|---|---|---|---|---|---|
| in (%) | 8228 | 8229 | 8230 | New 1 | New 2 |
| SiO₂ | 82.1 | 87.0 | 83.6 | 83.0 | 82.5 |
| B₂O₃ | 12.3 | 11.6 | 11.0 | 12.5 | 8.6 |
| Al₂O₃ | 5.3 | — | 2.5 | 4.5 | 5.5 |
| Na₂O | — | 1.4 | 2.2 | — | — |
| K₂O | — | — | 0.3 | | |
| Fining agent | 0.05-0.2 | 0.05-0.2 | 0.05-0.2 | 0.05-0.2 | 0.05-0.2 |
| α (×10⁻⁶) | 1.3 | 2.0 | 2.7 | 1.15 | 1.0 |

The transitional glass materials with the type designations 8228, 8229 and 8230 have coefficients of thermal expansion of 1.3×10⁻⁶ K⁻¹, 2.0×10⁻⁶ K⁻¹ and 2.7×10⁻⁶ K⁻¹ respectively and are therefore excellently suited for the production of a fused joint between silica glass and Duran glass. All the glass material types listed in Table 1 have a refractive index of less than approximately 1.47. The types of glass material in columns 4 and 5 cannot be produced with conventional, non-iridium-containing crucibles according to the prior art.

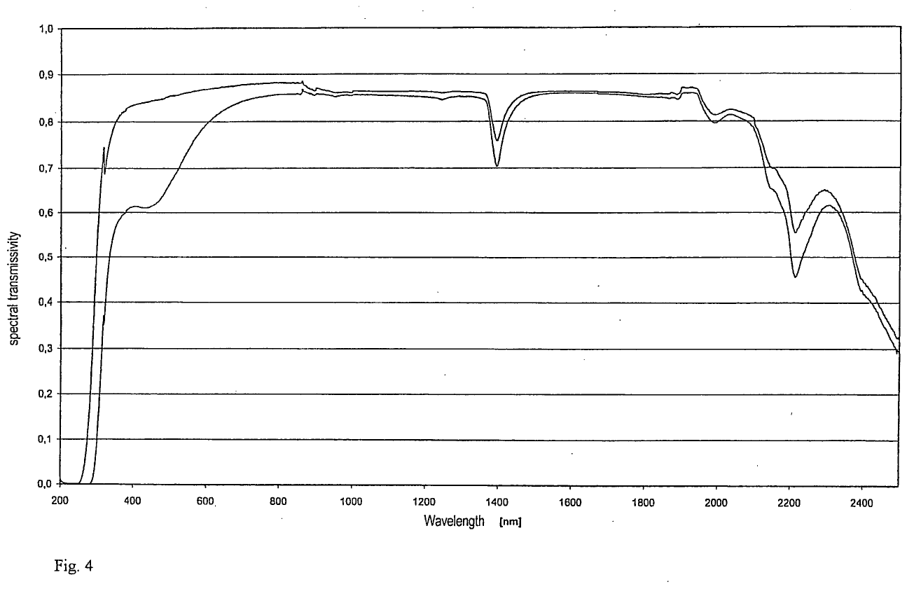

Due to the much higher temperatures made possible by the invention, it is possible to produce new types of glass materials and glass ceramic materials with the aforementioned composition with previously unattainable properties. An example of this may be found in FIG. 4, which shows the spectral transmission of the type of glass material designated 8228 in Table 1. FIG. 4 shows the spectral transmission of a type of glass 8228 which was produced with a device according to the invention and in accordance with the example of an embodiment 1 described in detail below, compared with a conventional, non-iridium-containing crucible in accordance with the prior art at temperatures of 1760° C. In FIG. 4, the upper curve represents the spectral transmission of a type of glass material designated 8228 produced according to the invention in accordance with the following example of an embodiment 1 and the lower curve represents the spectral transmission of a type of glass material designated 8228 according to the prior art.

As FIG. 4 shows, the spectral transmission is higher in the near UV (ultraviolet) range and sets in at about 30 nm earlier. As FIG. 4 shows, the spectral transmission of the type of glass material according to the invention between approximately 400 nm and approximately 800 nm is much higher than the spectral transmission of the corresponding type of glass material according to the prior art. In particular, the glass material according to the invention is characterised by the fact that the transmission in the aforementioned visible wavelength range, based on a substrate thickness of approximately 20 mm, is at least approximately 65%, more preferably at least approximately 75% and even more preferably at least approximately 80%. Transmission levels this high have not been observed in types of glass materials with a similar composition according to the prior art and neither can they be achieved according to the prior art because of the much lower processing temperatures due to the use of non-iridium-containing material for the crucible.

As FIG. 4 also shows, the water absorption bands at about 1350 nm and approximately 2200 nm are much lower with the glass material according to the invention than the corresponding water absorption bands with a corresponding glass material according to the prior art. The smaller water absorption bands may be attributed to the much higher processing temperatures compared to the prior art which result in the further expulsion of water and an even more efficient reduction of hydrogen-containing compounds in the molten glass during the fining process.

In particular, the glass material 8228 according to the invention, and also other types of glass materials with a glass composition according to the invention, are characterised by the fact that, based on a substrate thickness of approximately 20 mm, the transmission in the range of the water absorption band at approximately 1350 nm is at least approximately 75% and/or the transmission in the range of the water absorption band at approximately 2200 nm based on a substrate thickness of approximately 20 mm is at least approximately 50%, more preferably at least approximately 55%.

The following describes the production of glass materials or glass ceramic materials according to the invention with reference to preferred examples of embodiments.

### EMBODIMENT EXAMPLE 1

The following conditions were selected for the glass material 8228 (see Table 1):

The following Table 2 summarises the weighed portions of the raw materials used for 26.25 kg of the glass material with the composition 8228 according to example 1 (8228) in Table 1:

TABLE 2

| Oxide | Ma % | Raw material | Weighed portion [g] |
|---|---|---|---|
| SiO₂ | 82.1 | Silica flour | 18570 |
| B₂O₃ | 12.3 | Boric acid | 4952 |
| Al₂O₃ | 5.3 | Aluminium hydroxide | 1845 |
| SnO₂ | 0.2 | Tin (IV) oxide | 45 |

The properties of the molten glass are also show in example 1 (8228) in Table 1. For ease of handling, the mixture was divided into three batches and weighed or mixed individually. After mixing, the mixture was moistened with deionised water (3×800 ml) and then mixed again. This was in order to reduce dust formation in the mixture on introduction. Any large lumps of mixture that formed after moistening were then removed by screening and comminuted. This reduced the formation of inclusions in the mixture and seeds in the glass.

The average temperature on introduction was approximately 1900° C. at the crucible and approximately 1760° C. on the surface of the glass material.

The temperature was set manually by means of the voltage of the medium-frequency heating. Here, the voltage set was between 65% and 67% corresponding to 355V-370V. This produces a power of approximately 55% (˜28 kW) in a commercially available frequency converter (50 kW maximum power).

The amount introduced was approximately 4-6 porcelain spoons (approximately 70 g of mixture in each) every 15 minutes. The inclusion of atmospheric oxygen via the loose mixture could not be avoided with this method, but was of advantage, since it prevented the reduction of the glass components.

During the melting operation (T (crucible)>700° C.), approximately 6 l/min of argon were blown into the container space and approximately 3 l/min of argon into the actual interior of the crucible. Other inert gases such as nitrogen or mixture thereof are also a feasible alternative for larger systems for cost reasons, at least in the external area. Consideration should be paid to interaction with the glass in the interior of the crucible. However, a small amount of residual oxygen (up to approximately 2%) is not disadvantageous with regard to the reduction of different glass components.

Due to the relatively high melt volume, the melting down took two days. With a similar glass bath height, the period required for the fining of the glass was approximately the same as that with the 7-l (7 liter) structure. Since the diameter of the tube was 10 mm smaller (30 mm in the 7-l structure, >20 mm in the Ir crucible), the time required to produce the rods increased to two days. Here, throughput could be increased by increasing the tube diameter to up to 35 mm.

As is evident from the above explanation, although the processing times were approximately the same as those for melting crucibles made of PtRh30, the volume increased by a factor of 2 so that throughput per time unit increased by a factor of 2.

In addition to the use of high-melting raw materials, the high melting temperatures also permit the use of non-toxic high-temperature fining agents such as, for example SnO₂ instead of As₂O₃. Therefore, the amount of fining agent required is corresponding less than that determined for the PtRh30 crucible. Glass compositions that cannot be melted or are very expensive to melt due to their high viscosity may be produced economically in the iridium crucible. In addition to the high temperatures, iridium has the advantage over the PtRh30 alloy that it causes less colour cast (Rh) in the glass material. This means it is possible to produce products meeting optical requirements. This is demonstrated in FIG. 4. The better transmission in the visible range of the sample melted in the Ir crucible is clearly evident. Here, visually there is a slightly yellow colour effect, while a clear reddy-brown colour cast occurs when PtRh30 is used. The water bands were less intensively formed in the IR spectral range; this was a result of the much higher melting temperature.

The following lists some other types of glass materials that may be melted with the device according to the invention.

Cordierite-like glass ceramic materials comprising SiO₂ in the range between 40% and 60%, Al₂O₃ in the range between 25% and 45% and MgO in the range from 10%-20%.

Expediently, the glass composition may also comprise up to approximately 10%, preferably up to approximately 5%, further high-melting oxides for example TiO₂, ZrO₂, Nb₂O₅, Ta₂O₅ or WO₃ or mixtures thereof. In principle, MoO₃ is also possible, but its use could result in the discoloration of the glass depending on the application.

The arrangement of crucible and outlet tube may be used to produce different types of formed parts such as rods, fibres, tubes, ribbons (glass strips) and bars or cast parts. Before commencing the forming, the crucible temperature is reduced and the tube heating switched on. The temperature at the end of the outlet tube is set to the processing temperature (corresponding to a viscosity of 10⁴ dpa/s). The diameter of the formed part is set by the parameters ‘temperature’ and ‘drawing speed’. For tubes and rods, a separately heated (directly or indirectly via a muffle) die is arranged at the end of the tube to set the external diameter. For tubes, the wall thickness is set by means of a dual die. Since this is a discontinuous process, the glass level in the crucible drops during the forming, corresponding to the decrease in the static pressure. The drop in the glass level is compensated by regulating the drawing speed (generally by means of a drawing machine comprising two powered rollers) or the temperature or the pressure above the molten glass. The dimensions of the parts depend upon the tube diameter in each case. For example, 20 to 400 μm rods (fibres) are produced with a 30 mm tube diameter. In combination with a dual die for the production of tubes, dimensions of 18 mm to the capillaries are possible. Depending upon the type of glass material or glass ceramic material and the corresponding expansion, during the forming, thermal stresses occur on the condition α>5, but these may be compensated by selective thermal after-treatment. The use of iridium as the tube material and the resulting low wettability (adherence of the glass material to the tube walls) makes narrower production tolerances possible.

For the production of ribbons, the glass material runs out of the outlet tube on water-cooled rotating rolls. The tube diameter is adapted according to the glass viscosity. Depending on the roll spacing, glass struts without defined dimensions are produced.

Exemplary embodiment for the production of cordierite ribbons.

The following conditions were selected for the cordierite:

The following table summarises the weighed portions for the raw materials used for 26.4 kg of the glass material with the composition according to column 2 of the Table.

| Oxide | Ma % | Raw material | Weighed portion |
|---|---|---|---|
| Al₂O₃ | 35 | Aluminium monohydrate | 11907.2 |
| | | (AIO(OH)) | |
| MgO | 15 | Magnesium carbonate | 9000.0 |
| SiO₂ | 50 | Silica flour | 13218.5 |

The properties of the molten glass material are also shown in the above table for the embodiment example cordierite. For ease of handling, the mixture was divided into three batches and weighed or mixed individually. After mixing, the mixture was moistened with deionised water (3×800 ml) and then mixed again. This was in order to reduce dust formation in the mixture on introduction. Any large lumps of mixture that formed after moistening were then removed by screening and comminuted. This reduced the formation of inclusions in the mixture and seeds in the glass.

The average temperature on introduction was approximately 1850° C. at the crucible. The temperature was set on a regulator according to the specifications.

The amount introduced was approximately 6-8 porcelain spoons (approximately 70 g of mixture in each) every 15 minutes. The inclusion of atmospheric oxygen via the loose mixture could not be avoided with this method, but was of advantage, since it prevented the reduction of glass components.

During the melting operation (T (crucible)>700° C.), approximately 6 l/min of argon were blown into the container space and approximately 3 l/min of argon into the actual interior of the crucible. Other inert gases such as nitrogen or mixture thereof are also a feasible alternative for larger systems for cost reasons, at least in the external area. Consideration should be paid to interaction with the glass in the interior of the crucible. However, a small amount of residual oxygen (up to approximately 2%) is not disadvantageous with regard to the reduction of different glass components.

Due to the relatively high melt volume, the melting down took 1.5 days. Since the number of bubbles is irrelevant for the production of ribbons, the fining time could be kept very short at 3-6 h and/or a low viscosity specified.

When rolling the ribbons, the temperature in the crucible and in the tube was approximately 1650° C. The throughput was approximately 200 g/min to 300 g/min. This results in a 100% or 200% increase in throughput respectively compared to the conventional method.

As is evident to a person skilled in the art from the above description, the invention includes numerous other aspects that may in principle also be claimed separately.

The aforementioned method may, in principle, be use to produce glass ceramic materials with any compositions. Preferably, glass ceramic materials are produced with compositions as disclosed in the following patents or patent applications and the content of their disclosures is expressly included in this patent application by reference: EP 0 220 333 B1 corresponding to U.S. Pat. No. 5,212,122, DE 196 41 121 A1, DE 43 21 373 C2 corresponding to U.S. Pat. No. 5,446,008, DE 196 22 522 C1 corresponding to U.S. Pat. No. 5,922,271, DE 199 07 038 A1 corresponding to U.S. Ser. No. 09/507,315, DE 199 39 787 A1 corresponding to WO 02/16279, DE 100 17 701 C2 corresponding to U.S. Ser. No. 09/829,409, DE 100 17 699 A1 corresponding to U.S. Ser. No. 09/828,287 and EP 1 170 264 A1 corresponding to U.S. Pat. No. 6,515,263.

The present application claims convention priority of German patent application no. 103 48 466.3, filed on Oct. 14, 2003, the whole content of which is hereby expressly incorporated by reference.

As will become apparent to a person skilled in the art when studying the present application, many variations and modifications of the subject-matter of this application can be performed without leaving the spirit of the invention and the scope of the appended claims. Any of such variations and modifications within the scope of the present invention and of the appended claims are therefore intended to be covered by the present application.

### List of Reference Numbers

1 Melting device
2 Crucible
3 Induction coil
4 Outlet tube
5 Heating device
6 Crucible wall
7 Upper edge
8 Weld seam
9 Base
10 Conical segment
11 Pipe section
12 Pipe section
13 Pipe section
14 Pipe section
15 Draw die
16 Weld seam
17 Connections for thermocouples
18 Lid
19 Lower container section
20 Upper container section
21 Cover of the upper container section
22 Gas inlet
23 Fireproof cylinder
24 Pellet filling
25 First base element
26 Second base element
27 Sleeve for temperature sensor
28 Leadthrough
29 Coping
30 Leadthrough for media supply
31 Cover for crucible 2
32 Screening for the outlet tube 4
33 Orifice
34 Electrical connection
35 Upper coolant connection
36 Lower coolant connection
37 Upper coolant connection
38 Lower coolant connection
39 Transitional area
40 Coping

1. A device for the production of high-melting glass materials or high-melting glass ceramic materials, comprising a vessel for accommodating molten glass and a container which accommodates the vessel, said vessel having a tubular outlet wherein:
said vessel and a first section of the tubular outlet is formed of iridium or of a material with a high iridium content, wherein the container is designed to accommodate the vessel and the first section of the tubular outlet under a protective gas atmosphere in order to prevent oxide formation of the iridium or the material with a high iridium content.

2. The device according to claim 1 in which the tubular outlet comprises a second section and one of the first and the second sections is divided into a plurality of segments whereby at least one segment of the second section comprises an oxidation-resistant alloy and is exposed to an ambient atmosphere.

3. The device according to claim 1 whereby the tubular outlet is designed as a hot forming device for shaping the molten glass into a formed part or comprises such a device.

4. The device according to claim 1 in which the iridium comprises an iridium content of at least 99%, preferably at least 99.5% and even more preferably at least 99.8%.

5. The device of claim 1 in which the material with a high iridium content comprises a platinum group metal alloy with an iridium content of at least 95%, preferably at least 96.5% and even more preferably at least 98%.

6. The device according to claim 2 in which the oxidation-resistant alloy is a platinum group metal alloy comprising 30% by weight to 99% by weight platinum and into which is mixed an element from a group comprising iridium (Ir), osmium (Os), palladium (Pd), rhodium (Rh) and ruthenium (Ru) whereby the oxidation-resistant alloy is preferably a PtRh30 alloy and even more preferably a PtRh20 alloy.

7. The device according to claim 2 in which the ratio of a length of the first section to a length of the second section is approximately 2.0 and a wall thickness of the first section is approximately 70% of the wall thickness of the second section whereby a heating current from a common heating current source is supplied to the segments of the first and second sections.

8. The device according to claim 2 in which a heating current from separate heating current sources is supplied to the segments of the first and second sections.

9. The device according to claim 2 in which the tubular outlet is designed as an outlet tube whereby in a transitional range of the outlet tube a segment of the second section is connected to a segment of the first section by means of a plug connection so that a bead comprising a low-melting material in the second section lies around the high-melting material in the first section which becomes jammed on the stresses that occur on solidification.

10. The device according to claim 1 in which the vessel is covered by a cover that preferably comprises an oxidation-resistant alloy and more preferably comprises a PtRh20 alloy.

11. The device according to claim 10 in which the vessel and the cover has a pressure-tight design.

12. The device according to claim 11 in which the vessel comprises a gas inlet in order to supply an inert gas into an interior volume of the vessel whereby a control or regulating device is provided to control or regulate a pressure of the inert gas in the interior.

13. The device according to claim 1 in which an orifice ratio h/L of the vessel is very much greater than 1 whereby h is a maximum internal height of the vessel and L is a maximum distance from side walls of the vessel.

14. The device according to claim 1 in which the container comprises a gas inlet for supplying an inert protective gas into the interior of the container connecting the container with a gas reservoir that supplies the inert protective gas to the container in order to maintain neutral to slightly oxidising conditions in the interior of the container.

15. The device according to claim 14 in which the gas reservoir contains an inert protective gas with an oxygen content of between 5×10⁻³% and 5% and more preferably between 0.5% and 2%.

16. The device according to claim 13 in which the container has a pressure-tight design whereby at least one gas outlet is provided to discharge the inert protective gas from the interior of the container.

17. The device according to claim 1 in which the vessel is surrounded by an induction coil that is preferably water-cooled.

18. The device according to claim 17 in which a heat-resistant cylinder is arranged between a side wall of the vessel and the induction coil.

19. The device according to claim 18 in which a filling of heat-resistant pellets is provided between the side wall of the vessel and the cylinder.

20. The device according to claim 19 in which the pellets have diameter of at least 2.0 mm, more preferably at least 2.5 mm and even more preferably at least 3.0 mm whereby the pellets preferably comprise magnesium oxide (MgO) or ZrO₂.

21. A method for the production of high-melting glass materials or glass ceramic materials, said method comprising the steps of:
providing a vessel to accommodate molten glass, said vessel comprising a tubular outlet,
disposing said vessel in a container,
introducing a raw material with a prespecified composition into the vessel, and
melting the raw material to produce molten glass and fining the molten glass, whereby
the vessel and a first section of the tubular outlet are provided of iridium or a material with a high iridium content and a protective gas atmosphere is provided in the container in such a way that the vessel and the first section of the tubular outlet are accommodated in the container under the protective gas atmosphere that prevents oxide formation of the iridium or the material with a high iridium content.

22. The method according to claim 21 whereby one of the first section and of a second section of the tubular outlet is provided in such a way that at least one segment of the second section comprises an oxidation-resistant alloy and is exposed to an ambient atmosphere.

23. The method according to claim 21 in which the iridium comprises an iridium content of at least 99%, preferably at least 99.5% and even more preferably at least 99.8%.

24. The method of claim 21 in which the material with a high iridium content comprises a platinum group metal alloy with an iridium content of at least 95%, preferably at least 96.5% and even more preferably at least 98%.

25. The method according to claim 23 whereby an inert protective gas is supplied to the container in order to maintain neutral to slightly oxidising conditions in the interior of the container.

26. The method according to claim 25 in which the inert protective gas supplied has an oxygen content of between 5×10⁻³% and approximately 5% and more preferably between approximately 0.5% and approximately 2%.

27. The method according claim 1 in which
the molten glass is at first held in the vessel in a first operating mode for fining at a temperature way above the processing temperature for the molten glass while the tubular outlet is held at a temperature at which the molten glass forms a stopper that plugs the outlet and in which
the temperature of the molten glass in the vessel is reduced in a second operating mode after the fining to the processing temperature while the tubular outlet is heated to the processing temperature so that the stopper dissolves and the molten glass leaves the tubular outlet.

28. The method according to claim 27 in which the temperature during the first operating mode is at least 2000° C., more preferably at least 2100° C. and even more preferably at least 2200° C.

29. The method according to claim 21 in which the glass composition comprises 80% to 90% SiO₂, 0% to 10% Al₂O₃, 0% to 15% B₂O₃, less than 3% R₂O whereby the content of Al₂O₃ and B₂O₃ together is 7% to 20% and R stands for an alkali element from a group comprising Li, Na, K, Rb and Cs.

30. The method according to claim 29 in which the glass composition further comprises high-melting oxides of up to 20% MgO and/or up to 10%, more preferably up to 5% of TiO₂, ZrO₂, Nb₂O₅, Ta₂O₅, WO₃ or MoO₃ or mixtures thereof.

31. The method according to claim 27 in which the temperature during the first operating mode is at least 1800° C., more preferably 1850° C. and in which the glass composition comprises 40% to 60% SiO₂, 25% to 45% Al₂O₃ and 10% to 20% MgO.

32. The method according to claim 21 in which the molten glass is shaped into a formed part on its emergence from one of the tubular outlet and of a heat forming device provided on the tubular outlet.

33. The method according to claim 21 in which the molten glass in the vessel is stirred during the first operating mode with a stirring device comprising iridium or a material with a high iridium content, whereby the stirring device blows a gas into the molten glass to reduce and refine the molten glass.

34. A high-melting glass material or high-melting glass ceramic material produced according to a method according to claim 1 comprising:
80% to 90% SiO₂
0% to 10% Al₂O₃
0% to 15% B₂O₃ and
less than 3% R₂₀, whereby
the content of Al₂O₃ and B₂O₃ together is 7% to 20%, wherein
a transmission in the visible wavelength range between 400 nm and 800 nm based on a substrate thickness of 20 mm is at least 65%, more preferably at least 75% and even more preferably at least 80%.

35. The glass material or glass ceramic material according to claim 34 whereby the transmission in the range of a water absorption band at 1350 nm is at least 75%.

36. The glass material or glass ceramic material according to claim 34, wherein the transmission in the range of water absorption band at 2200 nm is at least 50%, more preferably at least 55%.

37. Use of the glass according to claim 35 as a transitional glass to connect two types of glass with different coefficients of thermal expansion.
